(19) United States
(12) Patent Application Publication
(10) Pub. No.: US 2022/0253102 A1
(43) Pub. Date: Aug. 11, 2022

(54) NOTEBOOK COMPUTER

(71) Applicants: Inventec (Pudong) Technology Corp., Shanghai (CN); Inventec Corporation, Taipei (TW)

(72) Inventors: Chun-Chi Lin, Taipei (TW); Szu-Yu Huang, Taipei (TW); Tong-Ting Wei, Taipei (TW); Kuan-Wei Lee, Taipei (TW); Jui-Hsiang Chen, Taipei (TW)

(21) Appl. No.: 17/196,992

(22) Filed: Mar. 9, 2021

(30) Foreign Application Priority Data
Feb. 9, 2021 (CN) 202110178773.9

(51) Int. Cl. G06F 1/16; G09G 5/38

(52) U.S. Cl. CPC G06F 1/1649; G09G 5/38; G09G 2340/0492; G06F 1/1686; G09G 2330/026; G06F 1/1616

(57) ABSTRACT

A notebook computer includes a base, a first display device, a second display device and a camera. A first side of the first display device is pivotally connected to the base and the second display device is pivotally connected to a second side of the first display device, wherein the first side is opposite to the second side. The camera is disposed on the second display device. The second display device rotates with respect to the first display device to adjust an angle and a height of the camera.

### BACKGROUND OF THE INVENTION

### 1. Field of the Invention

The invention relates to a notebook computer and, more particularly, to a notebook computer with multiple display devices.

### 2. Description of the Prior Art

At present, a notebook computer has been considered a necessity by a lot of people in daily life. The conventional notebook computer only has one display device. When there are more than two users, it is impossible to watch the displayed information face to face at the same time, and it is not conducive to interaction and operation between more than two users. Furthermore, the number of frames that can be displayed on one single display device is limited. When multiple windows are opened at the same time, the multiple windows can only be stacked or collapsed, such that it cannot provide flexible display arrangement. In general, a camera is disposed on the display device of the notebook computer. When the user is sitting, a lens of the camera is lower than the eyes of the user, such that a shooting angle of the camera is upward, i.e. the lens of the camera cannot directly face the eyes of the user, and it will cause the image to be greatly deformed.

### SUMMARY OF THE INVENTION

The invention provides a notebook computer with multiple display devices, so as to solve the aforesaid problems.

According to an embodiment of the invention, a notebook computer comprises a base, a first display device, a second display device and a camera. A first side of the first display device is pivotally connected to the base and the second display device is pivotally connected to a second side of the first display device, wherein the first side is opposite to the second side. The camera is disposed on the second display device. The second display device rotates with respect to the first display device to adjust an angle and a height of the camera.

As mentioned in the above, the invention disposes the second display device on the first display device. A user may rotate the second display device to a direction identical to the first display device, so as to display a larger frame together. The user may also rotate the second display device to a direction opposite to the first display device, such that more than two users located at opposite directions of the notebook computer may watch frames displayed by the first display device and the second display device at the same time. Needless to say, the user may also use the first display device or the second display device individually according to practical requirements. Furthermore, the invention disposes the camera on the second display device. When the user rotates the second display device to a direction identical to the first display device, the user may rotate the second display device to adjust the angle and the height of the camera, so as to make the height of a lens of the camera close to the height of the eyes of the user. Accordingly, the eyes of the user will not be erratic and image distortion can be avoided. When the user rotates the second display device to a direction opposite to the first display device, the user may also rotate the second display device to adjust the angle and the height of the camera, so as to use the camera to record environmental information opposite to the user.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a perspective view illustrating a notebook computer according to an embodiment of the invention.

FIG. 2 is a perspective view illustrating the notebook computer shown in FIG. 1 from another viewing angle.

FIG. 3 is a perspective view illustrating a second display device shown in FIG. 1 rotating to a direction opposite to a first display device.

FIG. 4 is a perspective view illustrating the notebook computer shown in FIG. 3 from another viewing angle.

FIG. 5 is a front view illustrating the notebook computer shown in FIG. 1.

FIG. 6 is a perspective view illustrating the first display device and the second display device shown in FIG. 1 being closed.

FIG. 7 is a perspective view illustrating the second display device shown in FIG. 6 being opened.

### DETAILED DESCRIPTION

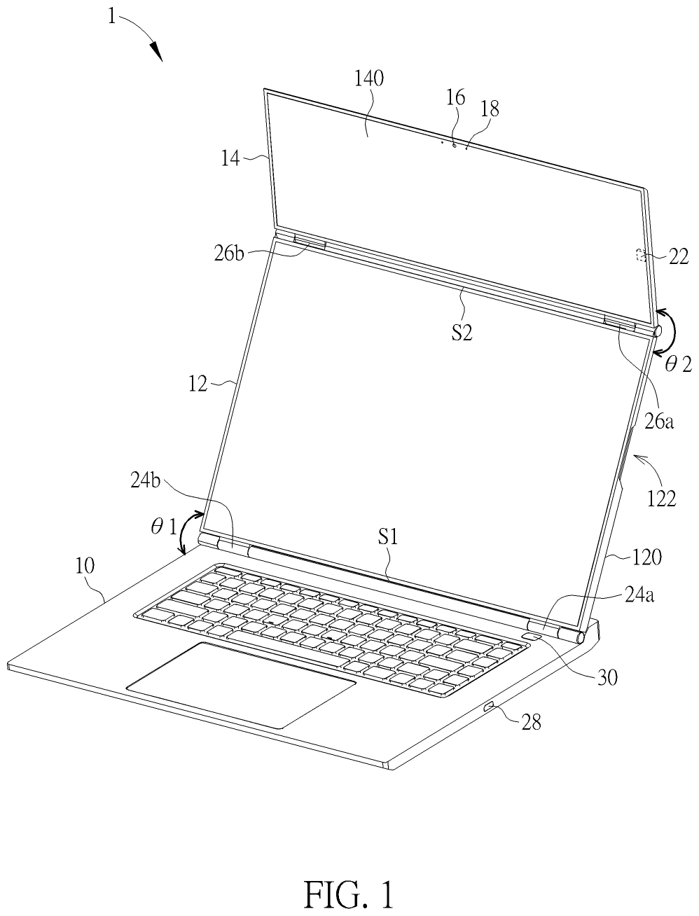

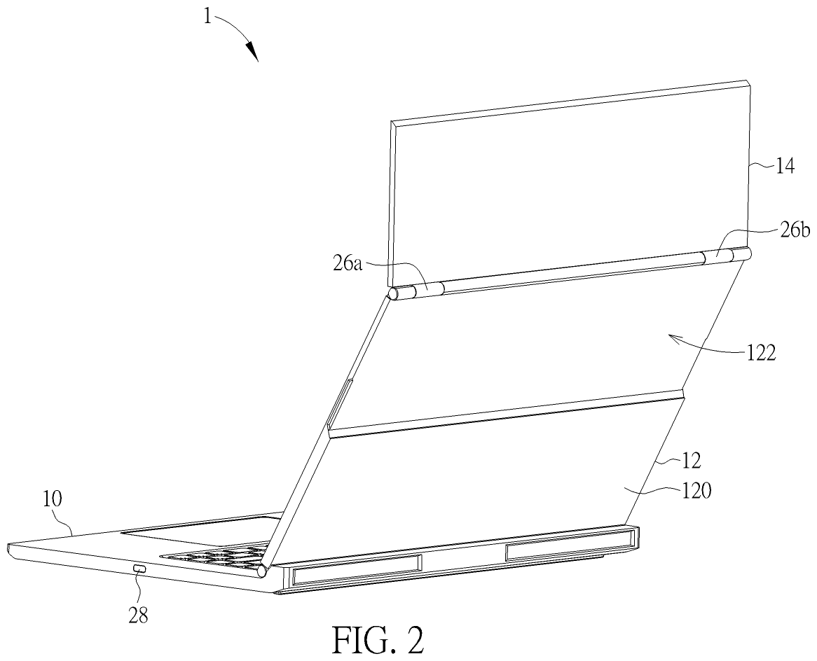

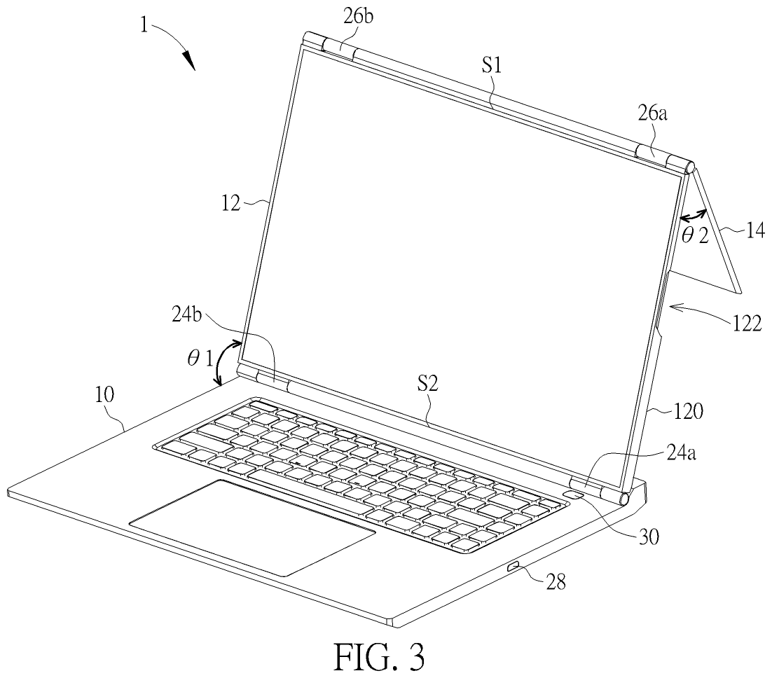

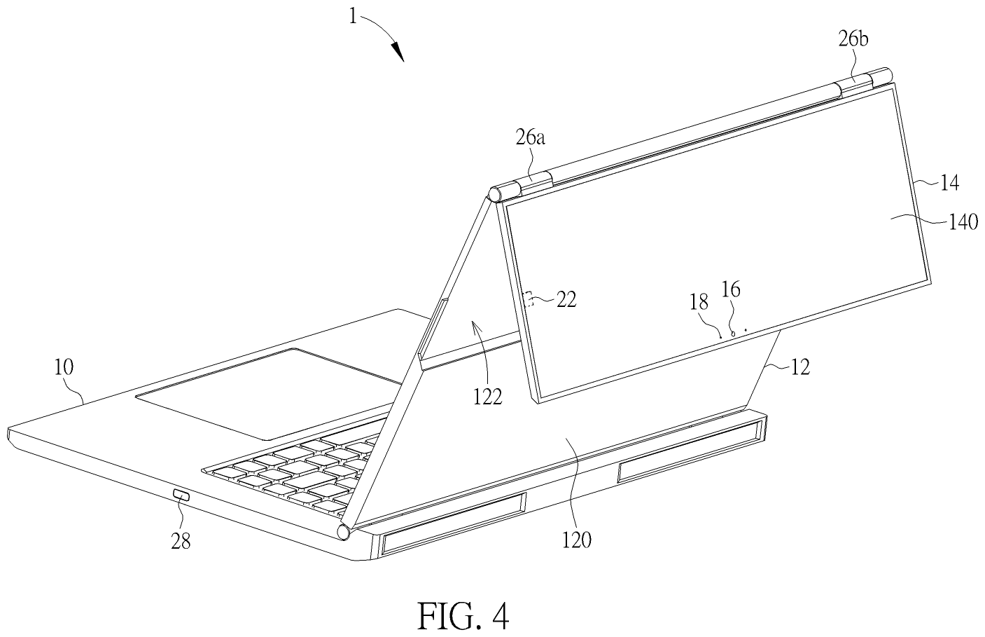

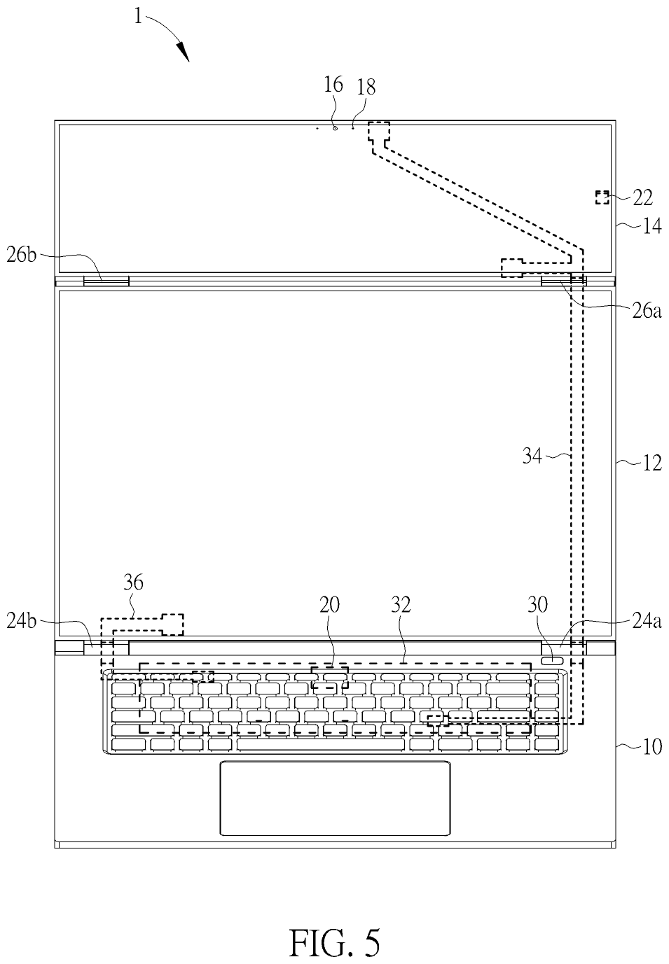

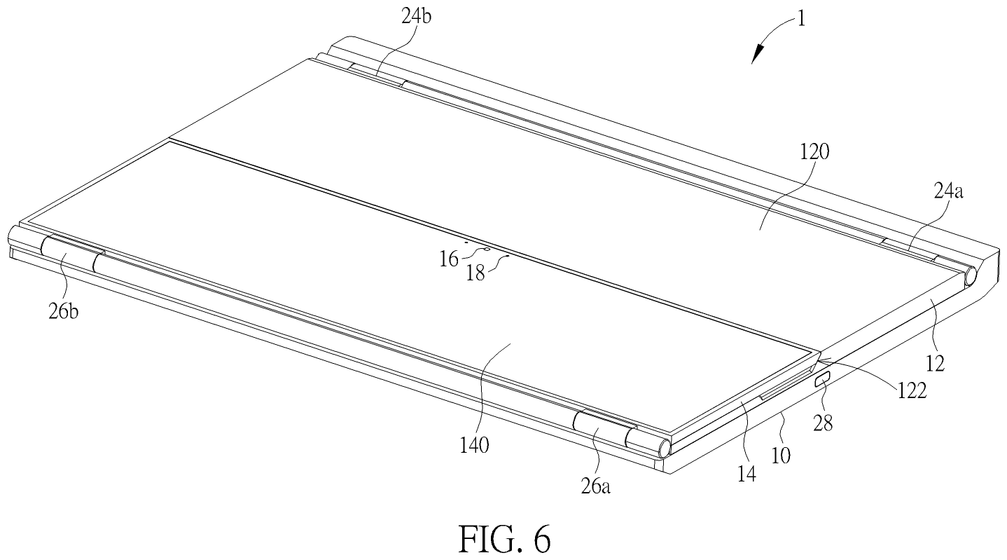

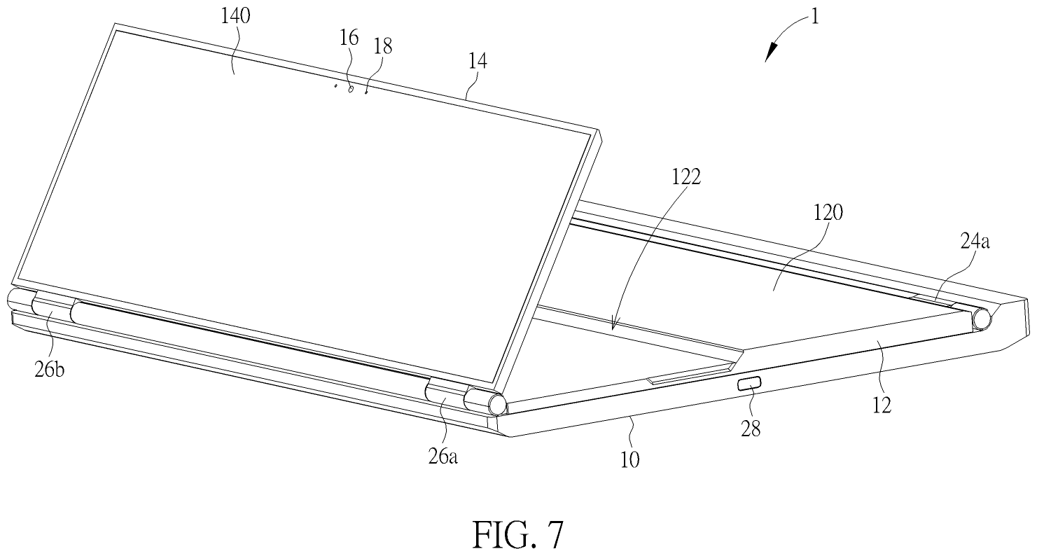

Referring to FIGS. 1 to 7, FIG. 1 is a perspective view illustrating a notebook computer 1 according to an embodiment of the invention, FIG. 2 is a perspective view illustrating the notebook computer 1 shown in FIG. 1 from another viewing angle, FIG. 3 is a perspective view illustrating a second display device 14 shown in FIG. 1 rotating to a direction opposite to a first display device 12, FIG. 4 is a perspective view illustrating the notebook computer 1 shown in FIG. 3 from another viewing angle, FIG. 5 is a front view illustrating the notebook computer 1 shown in FIG. 1, FIG. 6 is a perspective view illustrating the first display device 12 and the second display device 14 shown in FIG. 1 being closed, and FIG. 7 is a perspective view illustrating the second display device 14 shown in FIG. 6 being opened.

As shown in FIGS. 1 to 4, a notebook computer 1 comprises a base 10, a first display device 12, a second display device 14, a camera 16, a microphone 18, a processor 20, a sensor 22, two first pivots 24a, 24b, two second pivots 26a, 26b, a first switch 28 and a second switch 30. In general, the notebook computer 1 may be further equipped with some necessary hardware or software components for specific purposes, such as circuit board, memory, power supply, applications, communication module, etc., and it depends on practical applications.

A first side S1 of the first display device 12 is pivotally connected to the base 10 and the second display device 14 is pivotally connected to a second side S2 of the first display device 12, wherein the first side S1 is opposite to the second side S2. In this embodiment, the first side S1 of the first display device 12 is a lower edge of the first display device 12 and the second side S2 of the first display device 12 is an upper edge of the first display device 12. Therefore, a user may open the first display device 12 with respect to the base 10 and rotate the second display device 14 to a direction identical to the first display device 12 (as shown in FIGS. 1 and 2), so as to display a larger frame together. Furthermore, the user may also open the first display device 12 with respect to the base 10 and rotate the second display device 14 to a direction opposite to the first display device 12 (as shown in FIGS. 3 and 4), such that more than two users located at opposite directions of the notebook computer 1 may watch frames displayed by the first display device 12 and the second display device 14 at the same time.

The camera 16 and the microphone 18 are disposed on the second display device 14. As shown in FIG. 1, when the user rotates the second display device 14 to a direction identical to the first display device 12, the camera 16 and the microphone 18 are located on the higher second display device 14, such that the camera 16 and the microphone 18 may be close to the same level as a head of the user. The user may rotate the second display device 14 with respect to the first display device 12 to adjust an angle and a height of the camera 16, so as to make the height of a lens of the camera 16 close to the height of the eyes of the user. Accordingly, the eyes of the user will not be erratic and image distortion can be avoided. Still further, the user may also rotate the second display device 14 with respect to the first display device 12 to adjust an angle and a height of the microphone 18, such that the microphone 18 may receive sounds clearer. Moreover, as shown in FIG. 4, when the user rotates the second display device 14 to a direction opposite to the first display device 12, the camera 16 and the microphone 18 face a direction opposite to the user. At this time, the user may also rotate the second display device 14 to adjust the angle and the height of the camera 16 and the microphone 18, so as to use the camera 16 and the microphone 18 to record environmental information opposite to the user.

In this embodiment, the processor 20 may be disposed on a circuit board 32 in the base 10 and the sensor 22 may be disposed in the second display device 14. The sensor 22 may be electrically connected to the processor 20 by circuit layout. The sensor 22 is configured to sense a current angle of the second display device 14. The processor 20 controls a frame displayed by the second display device 14 to be oriented in an upright direction according to the current angle sensed by the sensor 22. For further explanation, when the user rotates the second display device 14 from a position shown in FIG. 1 to another position shown in FIG. 4, the processor 20 may control a frame displayed by the second display device 14 to rotate 180 degrees according to the current angle sensed by the sensor 22; and when the user rotates the second display device 14 from the position shown in FIG. 4 to the position shown in FIG. 1, the processor 20 may also control the frame displayed by the second display device 14 to rotate 180 degrees according to the current angle sensed by the sensor 22. Accordingly, as shown in FIG. 4, when the user rotates the second display device 14 to a direction opposite to the first display device 12, another user located at the side of the second display device 14 can also watch an upright frame. In this embodiment, the sensor 22 may be a G sensor.

In this embodiment, a rotating angle θ1 of the first display device 12 may be between 0 degrees and 125 degrees, and a rotating angle θ2 of the second display device 14 may be between 0 degrees and 230 degrees. In other words, the first display device 12 may rotate with respect to the base 10 between 0 degrees and 125 degrees, and the second display device 14 may rotate with respect to the first display device 12 between 0 degrees and 230 degrees.

The two first pivots 24a, 24b pivotally connect the first side S1 of the first display device 12 to the base 10, and the two second pivots 26a, 26b pivotally connect the second display device 14 to the second side S2 of the first display device 12. As shown in FIG. 5, signal lines 34 of the second display device 14, the camera 16, the microphone 18 and the sensor 22 may pass through one of the two second pivots 26a, 26b and one of the two first pivots 24a, 24b to connect the circuit board 32 in the base 10, and signal lines 36 of the first display device 12 may pass through the other one of the two first pivots 24a, 24b to connect the circuit board 32 in the base 10. In this embodiment, the signal lines 34 of the second display device 14, the camera 16, the microphone 18 and the sensor 22 pass through the second pivot 26a and the first pivot 24a to connect the circuit board 32 in the base 10, and the signal lines 36 of the first display device 12 pass through the first pivot 24b to connect the circuit board 32 in the base 10.

In this embodiment, a non-display surface 120 of the first display device 12 may have an accommodating recess 122. When the rotating angle θ2 of the second display device 14 is 0 degrees, the second display device 14 is accommodated in the accommodating recess 122 and a display surface 140 of the second display device 14 is exposed, as shown in FIG. 6. In this embodiment, the second display device 14 may comprise a touch panel (not shown). Accordingly, when the first display device 12 and the second display device 14 are closed, the user may operate the notebook computer 1 by the second display device 14, such that the notebook computer 1 may be used as a tablet computer.

In this embodiment, the first switch 28 may be disposed on an edge of the base 10. When the first display device 12 and the second display device 14 are closed (as shown in FIG. 6) and the notebook computer 1 is in a sleep mode, the first switch 28 may be configured to wake the second display device 14 up, so as to use the second display device 14 to perform operation and watch information. As shown in FIG. 7, when the first display device 12 is closed, the user may also open the second display device 14 to use the second display device 14 to perform operation and watch information.

In this embodiment, the second switch 30 may be disposed on the base 10. When the first display device 12 is opened (as shown in FIGS. 1 to 4), the second switch 30 may be configured to switch frames displayed by the first display device 12 and the second display device 14. For example, the second switch 30 may switch the frames displayed by the first display device 12 and the second display device 14 to one single large frame or two independent frames, so as to satisfy different requirements.

As mentioned in the above, the invention disposes the second display device on the first display device. A user may rotate the second display device to a direction identical to the first display device, so as to display a larger frame together. The user may also rotate the second display device to a direction opposite to the first display device, such that more than two users located at opposite directions of the notebook computer may watch frames displayed by the first display device and the second display device at the same time. Needless to say, the user may also use the first display device or the second display device individually according to practical requirements. Furthermore, the invention disposes the camera on the second display device. When the user rotates the second display device to a direction identical to the first display device, the user may rotate the second display device to adjust the angle and the height of the camera, so as to make the height of a lens of the camera close to the height of the eyes of the user. Accordingly, the eyes of the user will not be erratic and image distortion can be avoided. When the user rotates the second display device to a direction opposite to the first display device, the user may also rotate the second display device to adjust the angle and the height of the camera, so as to use the camera to record environmental information opposite to the user.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A notebook computer comprising:
a base;
a first display device, a first side of the first display device being pivotally connected to the base;
a second display device being pivotally connected to a second side of the first display device, the first side being opposite to the second side; and
a camera disposed on the second display device;
wherein the second display device rotates with respect to the first display device to adjust an angle and a height of the camera.

2. The notebook computer of claim 1, further comprising a microphone disposed on the second display device, wherein the second display device rotates with respect to the first display device to adjust an angle and a height of the microphone.

3. The notebook computer of claim 1, wherein a rotating angle of the first display device is between 0 degrees and 125 degrees, and a rotating angle of the second display device is between 0 degrees and 230 degrees.

4. The notebook computer of claim 1, wherein a non-display surface of the first display device has an accommodating recess; when a rotating angle of the second display device is 0 degrees, the second display device is accommodated in the accommodating recess and a display surface of the second display device is exposed.

5. The notebook computer of claim 1, further comprising a processor and a sensor, the processor being disposed in the base, the sensor being disposed in the second display device, the sensor sensing a current angle of the second display device, the processor controlling a frame displayed by the second display device to be oriented in an upright direction according to the current angle.

6. The notebook computer of claim 5, wherein the sensor is a G sensor.

7. The notebook computer of claim 1, further comprising two first pivots and two second pivots, the two first pivots pivotally connecting the first side of the first display device to the base, the two second pivots pivotally connecting the second display device to the second side of the first display device, signal lines of the second display device and the camera passing through one of the two second pivots and one of the two first pivots to connect a circuit board in the base, signal lines of the first display device passing through the other one of the two first pivots to connect the circuit board in the base.

8. The notebook computer of claim 1, further comprising a first switch disposed on the base, wherein when the notebook computer is in a sleep mode, the first switch is configured to wake the second display device up.

9. The notebook computer of claim 1, further comprising a second switch disposed on the base, wherein the second switch is configured to switch frames displayed by the first display device and the second display device.

10. The notebook computer of claim 1, wherein the second display device comprises a touch panel.
